(19) United States
(12) Patent Application Publication
(10) Pub. No.: US 2004/0117245 A1
(43) Pub. Date: Jun. 17, 2004

(54) METHOD AND SYSTEM FOR PERIODICALLY REWARDING USERS OF ELECTRONIC COMMUNICATIONS

(75) Inventor: Nicholas Briggs Gogerty, Nevada, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240

(73) Assignee: Mr. Nicholas Briggs Gogerty, Nevada, IA (US)

(21) Appl. No.: 09/693,252

(22) Filed: Oct. 20, 2000

(51) Int. Cl. G06F 17/60

(52) U.S. Cl. 705/14

(57) ABSTRACT

### Abstract of the Disclosure

A system and method for rewarding users of an electronic communication system which includes apparatus and steps for generating in real time, a unique ID for each message on the system and then later performing a periodic free random lottery drawing from the pool of unique IDs.

### Detailed Description of the Invention

### Background of Invention

In recent years, the volume of electronic communications has increased dramatically. Fierce competition exists between suppliers of communication services. Often, these communication services are largely undifferentiated from each other. In some cases, they are viewed as commodities by the consuming public; for example, mobile phone providers sell their services by the minute and compete on the per-minute cost and the number of "free" minutes allowed per billing period. Various methods have been attempted to differentiate these suppliers. Differentiation proposals have been made to financially reward users for their use. One example is described in U.S. Patent 6,016,338 issued to Bansal et al. on January 18, 2000, and entitled "Lottery method and apparatus having a tiered prize scheme" (hereafter the "Bansal Patent").

While this approach does have some utility, it also has some drawbacks. First of all, the Bansal Patent is limited in its detailed description to a telephone system which is not capable of e-mail or other text communication. Secondly, this system requires a verification of the eligibility of each participant for each entry into a lottery. This real-time verification approach is processor intensive and time consuming, especially when very high volumes of entries are being processed. Thirdly, because of its instant winner notification and the synchronous nature of telephone communication, the caller using the system described in the Bansal Patent must be actively engaged or interrupted in order to effect a notification of winning or failing to win a lottery. Other problems exist as well.

Consequently, there exists a need for improved methods and systems for rewarding users of electronic communications in an efficient manner.

### Summary of Invention

It is an object of the present invention to provide a system and method for rewarding users of an electronic communication system in an efficient manner.

It is a feature of the present invention to generate, in real time, a unique ID associated with each manually created message sent and received, to pre-registered users, over an electronic communication system.

It is another feature of the present invention to perform a periodic free lottery drawing with winners selected from the pool of unique IDs.

It is another feature of one embodiment of the present invention to append, to each message transmitted over the system, a passive (i.e. textual) notification of the recipient's status as a potential winner and of the then current dynamic prize amount for the next scheduled lottery drawing.

It is a feature of one embodiment of the present invention to provide a web-based e-mail system which uses the reward mechanism of the present invention.

It is another feature of the present invention to provide targeted advertising to users of the web-based e-mail system.

It is an advantage of the present invention to achieve improved efficiency in rewarding users of electronic communication systems.

Other objects, features, and advantages exist as well.

The present invention is an apparatus and method for rewarding users of electronic communication, which is designed to satisfy the aforementioned needs, provide the previously stated objects, include the above-listed features, and achieve the already articulated advantages. The present invention is carried out in a "message interruption-less" manner in a sense that the interruptions and delays involved in real-time verification of lottery entries and notification of winners have been greatly reduced.

Accordingly, the present invention is a system and method including steps and apparatus for issuing a unique ID, in real time, for each message processed by an electronic communication system, and later performing periodic free random lottery drawings from the pool of the unique IDs and, after delivery of the messages has been completed, providing notification of winning status to a pre-registered user.

### Brief Description of Drawings

The invention may be more fully understood by reading the following description of the preferred embodiments of the invention, in conjunction with the appended drawings wherein:

Figure 1 is a block/flow diagram view of a system and method of the present invention, which shows a lottery entry created by a sender of a message, who is a pre-registered user.

Figure 2 is a block/flow diagram view of a system and method of the present invention, which shows a lottery entry created by a recipient of a message, who is a pre-registered user.

Figure 3 is a block/flow diagram view of a system and method of the present invention, which shows a lottery entry created by a sender of a message, as in Figure 1, with additional details relating to generation and use of unique ID tags.

Figure 4 is a process/flow diagram of a simplified embodiment of the present invention.

Figure 5 is a process/flow diagram describing a dynamic prize and notification of eligibility for the same.

Figure 6 is a simplified system architecture of a web-based e-mail embodiment of the present invention.

Figure 7 is a simplified block diagram of a system of the present invention which uses handheld wireless communication systems.

### Detailed Description

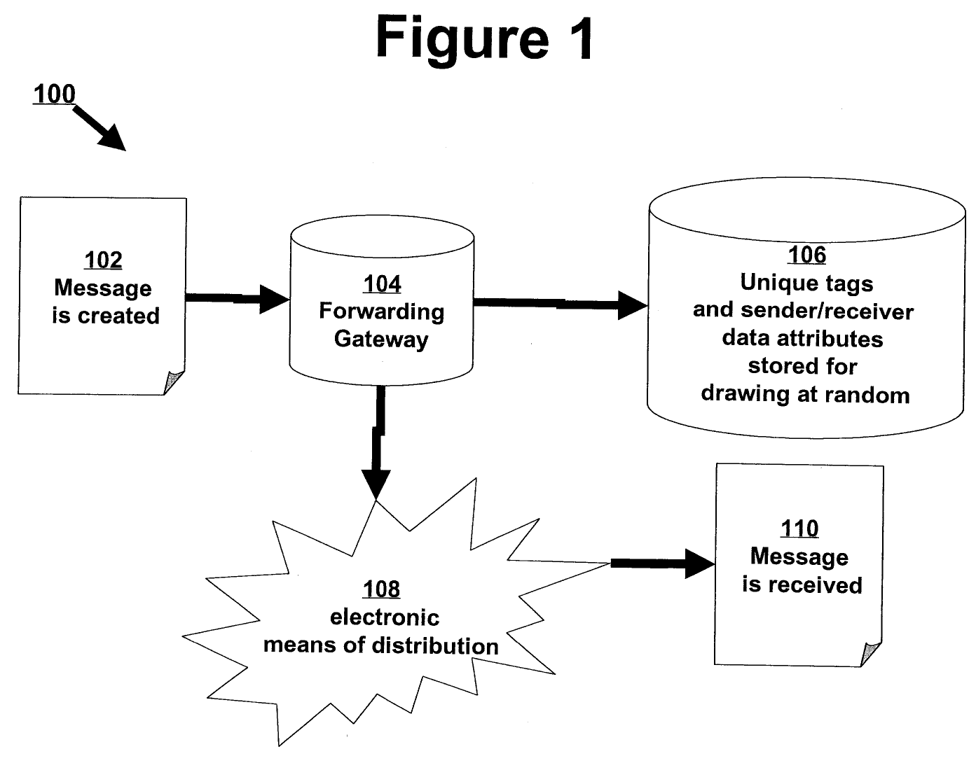

Now referring to the drawings wherein like numerals refer to like matter throughout, and more specifically referring to Figure 1, there is shown a system and method of the present invention generally designated 100, including a message creation block 102.

The sender message could be e-mail or other types of electronic messaging, SMS (short message system), voice-mail, video-mail, web-based e-mail, instant messaging, teletext, video, cellular phone-based messaging, paging, or any form of electronic messaging between two or more parties. The term "message" is intended to be expansive, including any type of message sent via an electronic, optical, or opto-electronic means, including, but not limited to, cable, telephone wire, wireless (RF, microwave, IR or other), optical fiber, etc.

The act of and apparatus for creating a message are well known in the art for each of the above message types and transmission media. A web-based e-mail system in which a user creates an e-mail message from a web page is just one example of numerous well-known methods of creating a message. The output of message creation block 102 is a message to be communicated to a recipient. This message is provided to a forwarding gateway 104. Forwarding gateway 104 can be any device or process which serves to aggregate, prepare, generate, or generally facilitate the sending of electronic messages through the electronic means of distribution 108. A forwarding gateway 104 may be software, hardware, or a combination of the two. In the above web-based e-mail example, the forwarding gateway 104 could be provided with a first computer software means which is well known in the art for allowing authors at a web page to create and send e-mail via the internet. The present invention, as well as prior art web-based e-mail service providers, such as Hotmail, etc., would also include additional known software for operating a web-based e-mail service. Forwarding gateway 104 would include a first computer software means. The user who creates the message in message creation block 102 is registered with the forwarding gateway 104. The forwarding gateway forwards the message on to the electronic means for distribution 108, which could be the Internet, or other network which might include some or all of the media, such as cable, telephone wire, wireless (RF, microwave, IR or other), optical fiber, etc. Ultimately, the message is received at message receive block 110. Except for the innovative lottery features described herein, the entire path 102, 104, 108, and 110 is well known in the respective arts of the following media cable, telephone wire, wireless (RF, microwave, IR or other), optical fiber etc. ID tag block 106 is unique to the present invention. Forwarding gateway block 104 performs well-known gateway functions. It also determines unique message details, such as sender ID, recipient ID, time and date of message, etc. and uses these details to associate a unique ID tag with each message, which unique message details and unique ID tags are processed by unique ID tag block 106. In this Figure 1, the user who creates the message at message create block 102 is pre-registered with and known by the forwarding gateway 104. In this Figure 1, the user who receives the message at message received block 110 is not a pre-registered user known to the forwarding gateway 104.

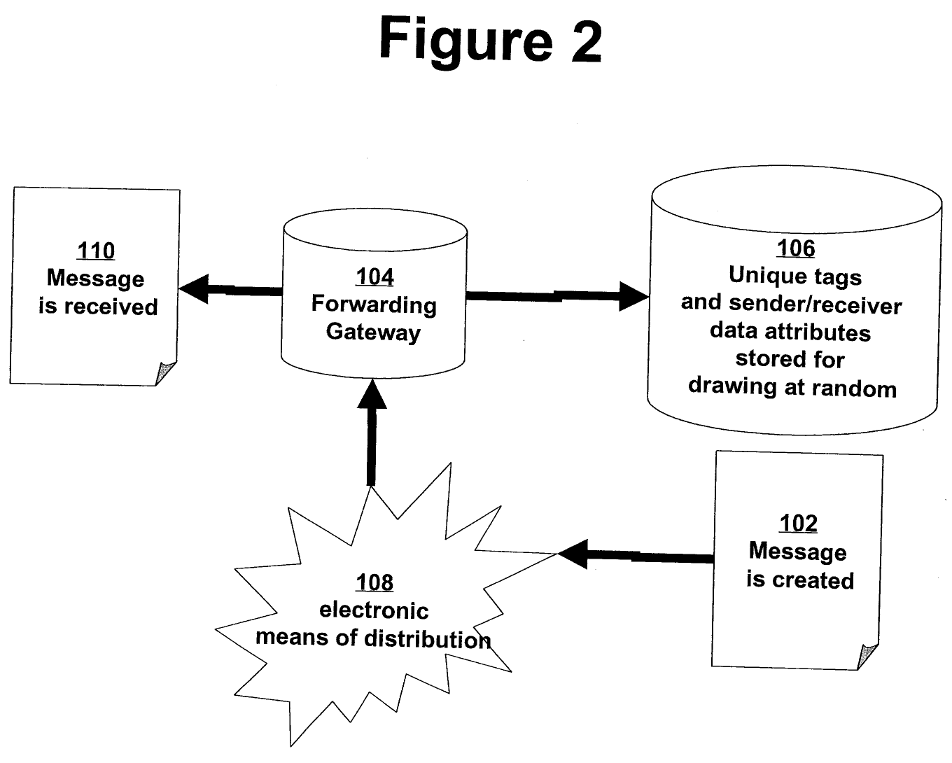

A more detailed understanding of the present invention can be achieved by now referring to Figure 2, which shows a similar situation to that shown in Figure 1, except the user at message create block 102 is not a pre-registered user, but the user at message received block 110 is pre-registered with and known by forwarding gateway 104. It is possible that both users at message create block 102 and message received block 110 are pre-registered with and known by forwarding gateway 104. In such cases, the present invention could be adapted to create two lottery entries one at message create block 102 and another at message received block 110.

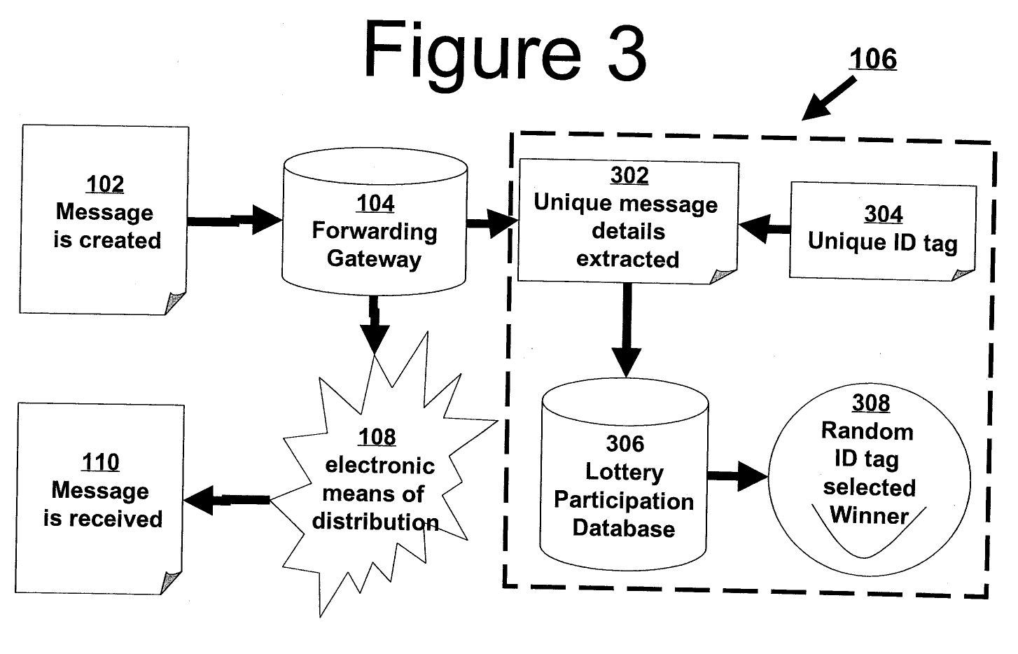

An even more detailed understanding of the present invention may be achieved by now referring to Figure 3, which gives more detailed information about unique ID tag block 106. Unique ID tag block 106 is intended to convey the processing of unique ID tags in the lottery system. Forwarding gateway 104 receives the message from message create block 102 and as shown by unique message details extracted block 302, the unique details of each message are extracted from the message. As discussed above, for the web-based e-mail embodiment, this could be the e-mail addresses of the sender and the recipient(s), as well as the time and date of the e-mail message. (Note, similarly for other embodiments using other message types and transmission media, these details would be things such as mobile telephone numbers, time and date of the call, etc.). Unique ID tag 304 represents a number generator which creates a unique ID for each message. This unique ID is associated with the unique message details extracted in unique message details extracted block 302. These uniquely identified details are then stored in lottery database of unique IDs 306. Steps 302, 304, and 306 may be accomplished by a first computer software means which accomplishes all of the steps. Alternatively, independent computer software programs could be used to accomplish the same result. Selection of random ID 308 represents the step and necessary apparatus or software to perform a random selection of a winner from the lottery database of unique IDs 306. Various well-known techniques could be employed for making the lottery winner selection. A second computer software means could be employed to perform the functions of selection of random ID 308. As with all hardware and software components of the present invention, varying amounts of integration and/or distribution of processing, programming, etc. can be employed. The decision to have the first computer means and the second computer means to be independent programs or merely different lines of code in the same program is a matter of designer's choice.

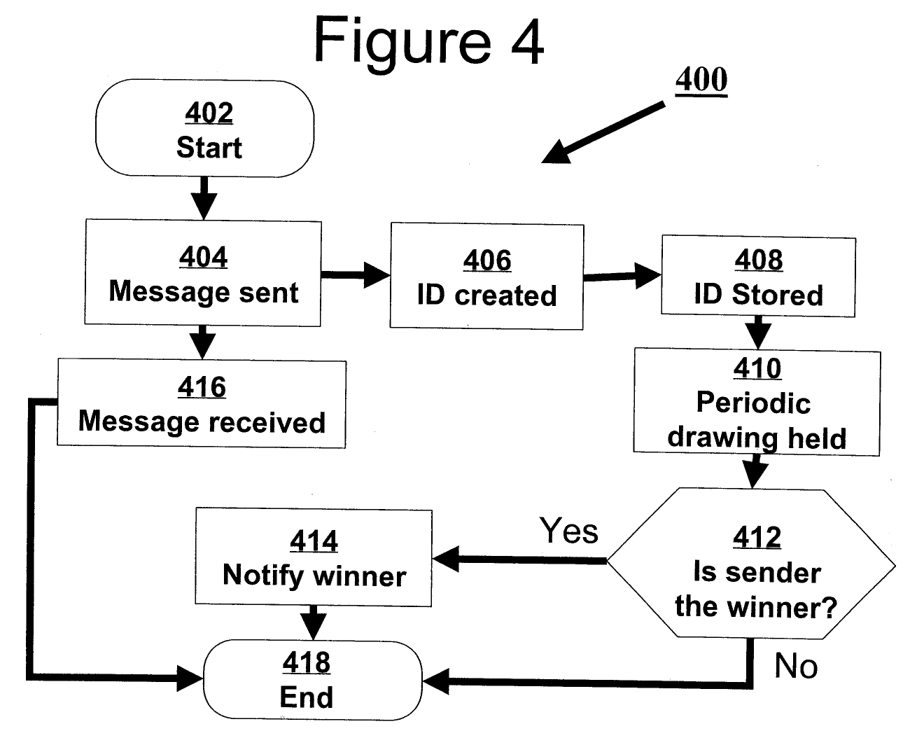

Now referring to Figure 4, there is shown a simplified process flow diagram of one embodiment of the present invention, which would apply the situation depicted in Figure 1. A person skilled in the art would recognize that a similar process chart could be drawn where the recipient is the pre-registered user. The process, generally designated 400, could proceed as follows: process starting point 402 represents the beginning of the process. However, it should be understood that various steps, such as pre-registration, occur before this process starting point 402. The discussion of this Figure 4 is focused upon the recurring steps associated with each message sent by a pre-registered user. Message creation and sending step 404 could be done by a pre-registered user on a PC, using a web page interface. The PC web page interface for creating e-mail messages could be similar to those used by Hotmail, Yahoo Mail, Excite Mail, etc. Advertising and user-targeted advertising can be provided to the pre-registered user when these pages for message creation are used. Other methods of creation and sending of web-based e-mail are possible, such as using an e-mail client such as Outlook Express, by Microsoft Corporation, and a POP 3 or other e-mail client/server protocol. In such cases, the system used to generate and target advertising to the user via the web page could be adapted or augmented to provide advertising e-mails to users who enter the lottery through a non-web page-based e-mail client.

The term "PC" is intended to be broadly construed herein to mean any computing device capable of sending text messages, such as PDAs, mobile phones, pagers, etc. ID creation step 406 involves a generation of a unique ID for each message. ID association and storage step 408 occurs next where the lottery entry is constructed of the unique details identifying the sender, recipient, etc. and the unique message ID created in ID creation step 406. Lottery drawing step 410 is done periodically, such as weekly, monthly, daily, etc. Step 410 could be done based upon an event other than the passage of time, such as when the amount of the prize reaches a certain level, or when the message volume reaches a predetermined level. Entry sorting step 412 suggests that each entry is compared to a winning ID to determine its status. If the entry is a winner, then winner notification step 414 is followed; if not, then the process proceeds to end of process 418. The lottery process again is a periodic process which does not require interruption of the message and real-time verification of the entry during the message delivery process. Once the message creation and sending step 404 has been completed and the unique message details have been extracted, the message delivery process occurs in a normal manner, with the message received step 416 occurring without any delays associated with entry sorting step 412 and winner notification step 414. Numerous ways of determining how to select the winning entry could be developed. The above-described lottery process is merely representative of those many approaches.

The notification of winning step can be accomplished with any means for notification. It may be preferred to generate an independent message to the pre-registered user, using the same message type and the same transmission media as was used for the message for which the winning lottery entry was generated. i.e., if a web-based e-mail message was the message which resulted in a winning lottery entry, then the pre-registered user is notified via an e-mail message to a web-based e-mail address associated with the winning lottery entry. The winning entry may be as a result of the pre-registered user either sending or receiving an e-mail message.

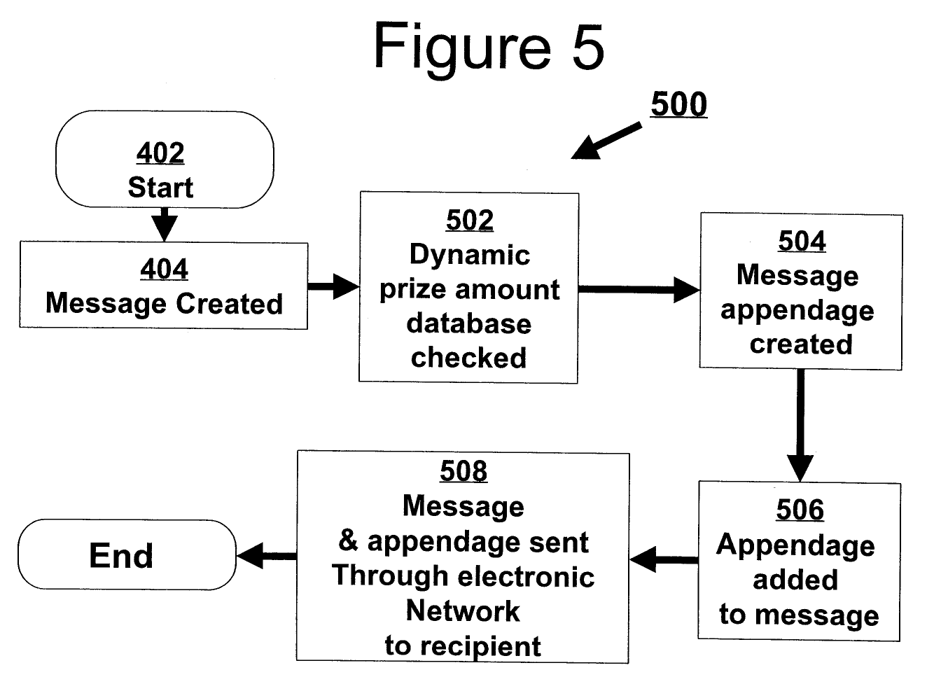

An alternate embodiment of the present invention is shown in Figure 5, which provides for a dynamic prize and notification of the potential winning status to the recipient. The prize can be a dynamic cash amount; i.e., it can change based upon one or more variables. Preferably, the amount of the dynamic prize is variable as a function of volume of messages being sent. Higher volumes through the system permit more opportunities for advertising and other revenue generation. In this web-based e-mail embodiment, the dynamic prize amount is determined by checking a database step 502, which associates volume of messages with available revenue for cash prizes. This dynamic amount is crucial to the profitability of the system and method of the present invention. Too low of a reward may be an insufficient incentive to provide product differentiation. Too high of a reward could jeopardize the profitability of the enterprise. The database is readily changeable to accommodate changes in advertising rates and other revenue generation. Systems other than using a database to determine the size of the dynamic award are contemplated. Message appendage creation step 504 represents the step of generating some text to be included with the e-mail message which indicates that recipient of the message is potentially eligible to win the amount of the dynamic prize. Other textual information may be included with the message such as advertising, a URL to a page which explains the lottery system and permits a new user to become a registered user and others. The message appendage is added to the message per step 506, which is sent per step 508 over the Internet to the recipient.

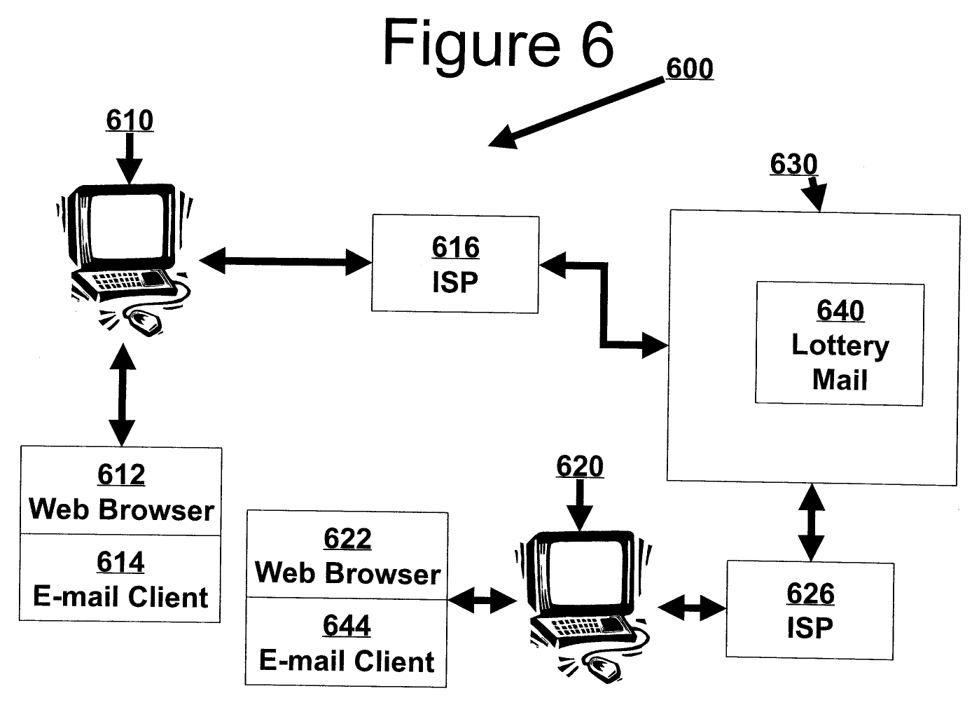

Now referring to Figure 6, there is shown a simplified architecture of a system of web e-mail embodiment of the present invention, generally designated 600. The system 600 is almost entirely well known in the art except for inclusion of the lottery mail server 640. System 600 includes a first user information appliance 610 and second user information appliance 620, which could be any device capable of communicating text messages over the internet 630. First user information appliance 610 and second user information appliance 620 may include a web browser 612 or 622, respectively and/or an e-mail client 616 or 626, respectively, which could be a client for connecting with POP 3 or other servers. First user information appliance 610 and second user information appliance 620 are coupled to the Internet 630 by some ISP 616 and 626 respectively.

Lottery mail server 640 is shown disposed in the block generally designated 630 for the Internet. Lottery mail server 640 is a server coupled to the internet which is capable of processing the lottery entries as described above. Lottery mail server 640 is also capable of handling e-mail in a manner similar to servers used for Hotmail, Yahoo mail, Excite mail, etc. In a manner similar to those employed by the Hotmail, Yahoo mail, and Excite mail servers, targeted advertising can be directed to users of these web-based e-mail systems. Also, the users of the present inventive system can be rewarded with extra lottery entries into the lottery database of unique IDs 306 by providing personal demographic and psychographic details through web pages associated with the registration of the user to the lottery mail server 640.

Lottery mail server 640 may in some embodiments be a prior art web-based e-mail server or combination of web-based e-mail servers, such as those used by Hotmail, Yahoo Mail, and Excite Mail, etc. (hereafter referred to as a web-based e-mail server) to run the entire operations of those web-based e-mail services, except that the lottery mail server 640 would include therein software, which is adapted and configured to perform the lottery functions described herein. The details of operation of a web-based e-mail service are well known due to their already widespread use. A person having ordinary skill in the art of designing web-based e-mail systems could, with the aid of the innovative disclosures herein, tailor existing web-based e-mail servers and systems to accomplish the lottery web-based e-mail system of the present invention, including the creation of apparatus and software and the operation of forwarding gateway 104 and unique ID tag block 106 of Figures 1-3, as well as the performance of steps 406, 408, 410, 412, and 414 of Figure 4 and steps 502, 504, 506, and 508 of Figure 5.

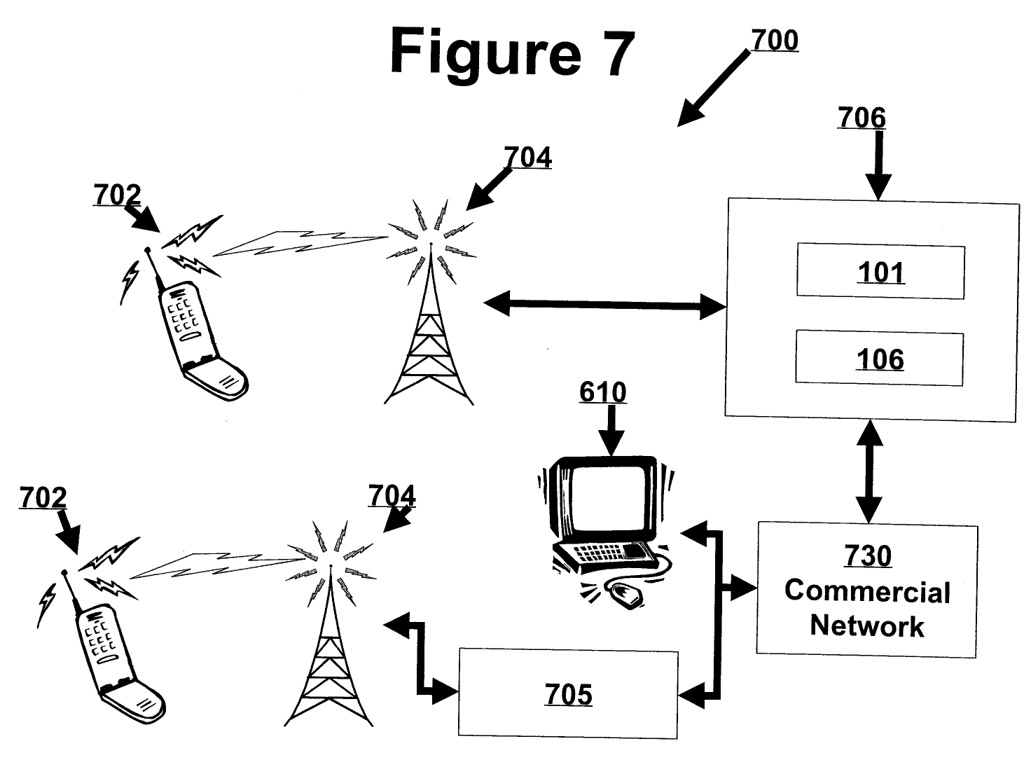

Now referring to Figure 7, there is shown an alternate embodiment of the present invention in which textual messages are sent via wireless technologies. For example, sender information appliance 702, which could be a mobile phone, PDA, pager, or any other device capable of wireless communication using any wireless text or video communication scheme, including, but not limited to internet e-mail, Short message service (SMS) or other textual messages to a reception station 704 which is coupled to a message processing system 706, which is shown as including a forwarding gateway 104 and a unique ID tag block 106. These systems, such as standard message processing system 705, without the lottery mail functions of forwarding gateway 104 and unique ID tag block 106 are well known in the art and could be readily adapted to provide the reward system and methods of the present invention. These wireless text messages could provide the same functionality of providing rewards, dynamic prizes, notification of potential winner status, and advertising as is described for the web-based e-mail system above.

Throughout this description, many references are made to e-mail messages and to the Internet, because it is believed that the benefits of the present invention will be readily apparent when it is applied to internet e-mail. However, it should be understood that the present invention is not intended to be so limited. It is intended to apply to any electronic messaging system, irrespective of message type and transmission media.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

What is Claimed is:

1.An apparatus for rewarding users of electronic communication systems comprising:
means for creating, by a plurality of pre-registered users, a plurality of messages and transmitting said plurality of messages;
a forwarding gateway means for receiving said plurality of messages and extracting therefrom message identification details which are unique to each of said plurality of messages;
said forwarding gateway means further forwarding each of said plurality of messages to an electronic communication network for ultimate delivery to a plurality of predetermined recipients;
a unique ID tag processing block for:
generating a plurality of unique ID tags, at least one for each of said plurality of messages;
associating each of said plurality of unique ID tags with message identification details from one of said plurality of messages to form a plurality of lottery entries;
storing said plurality of lottery entries; and,
periodically, after receipt of said plurality of messages by said plurality of predetermined recipients, randomly selecting one of said plurality of lottery entries as a winner of a prize; and,
means for notifying one of said plurality of pre-registered users of a winning status.

2.An apparatus of claim 1 wherein said electronic communications network is the Internet.

3.An apparatus of claim 2 wherein means for creating is a plurality of web page browsers.

4.An apparatus of claim 3 wherein said plurality of messages are internet e-mail messages.

5.An apparatus of claim 4 wherein said unique ID processing block is a computer server coupled to the internet, having software therein which is configured and adapted to perform predetermined lottery functions.

6.An apparatus of claim 5 wherein said computer server is a web-based e-mail server which contains software therein which is adapted and configured to perform lottery function.

7.An apparatus of claim 6 wherein said plurality of messages each has an appended message appended thereto which indicates a status as a potential lottery prize winner.

8.An apparatus of claim 7 wherein said appended message includes a reference to a dynamic lottery prize amount.

9.An apparatus of claim 8 wherein said dynamic lottery prize amount is variable in relation to a volume characteristic of messages processed by said forwarding gateway means.

10.An apparatus of claim 9 wherein said appended message includes a hypertext link to a web page coupled to web pages for registering new users.

11.An apparatus of claim 10 wherein said means for notifying employs an e-mail notification.

12.An apparatus of claim 11 wherein a free lottery entry is awarded to a new user who provides demographic information upon registering to become a pre-registered user.

13.An apparatus of claim 1 wherein said plurality of messages is a plurality of textual SMS messages.

14.An apparatus of claim 1 wherein said plurality of messages is a plurality of video-mail messages.

15.An apparatus comprising:
a web-based e-mail server,
first computer software means, coupled to said web-based e-mail server, said first computer software means for accepting textual data from pre-registered authors via a web page and for generating and sending, via the internet, an e-mail message in response to textual data entered on said web page;
second computer software means, coupled to said web-based e-mail server, for rewarding a user of said web-based e-mail server by creating a lottery entry for each e-mail message created and sent by said user; and,
third computer software means, coupled to said web-based e-mail server, for periodically determining a winner of a lottery cash prize based upon a selection of at least one lottery entry from a pool of lottery entries created as a result of e-mail messages previously input through said web page and previously delivered via the internet.

16. An apparatus of claim 15 further comprising:
software means for generating an appended message on said e-mail message, where said appended message includes a textual notification of a cash prize amount which may be available to a recipient of said e-mail message.

17.An apparatus of claim 16 wherein said appended message includes a textual notification of a cash prize which is dynamic and is at least in part established in relation to a dynamic e-mail message volume characteristic of said web-based e-mail server.

18.An apparatus of claim 17 further comprising software which creates a lottery entry for a new user that provides demographic information during a registration process to become a pre-registered author.

19.An apparatus of claim 18 wherein said first computer software means, said second computer software means, and said third computer software means are components of a single composite computer software program.

20.A method of rewarding a pre-registered user of an internet based e-mail system comprising the steps of:
extracting unique information for each e-mail associated with said pre-registered user;
generating a unique ID and a lottery entry for each such e-mail;
occasionally, after delivery of each such e-mail, selecting a lottery entry to receive an award; and,
notifying a winner in response to said step of selecting a lottery entry to receive an award.
